(19) United States
(12) Patent Application Publication
(10) Pub. No.: US 2008/0141831 A1
(43) Pub. Date: Jun. 19, 2008

(54) Hose clam locking pliers

(76) Inventor: David M. Ekola, Rochester, NH (US)

Correspondence Address: DAVIS BUJOLD & Daniels, P.L.L.C., 112 PLEASANT STREET, CONCORD, NH, 03301, US

(21) Appl. No.: 11/638,148

(22) Filed: Dec. 13, 2006

(51) Int. Cl. B25B 27/10

(52) U.S. Cl. 81/9.3; 29/428

(57) ABSTRACT

A hose clamp locking plier comprising a fixed handle supporting a fixed clamping jaw with a movable clamping jaw pivotally supported by the fixed handle and movable relative to the fixed clamping jaw. A movable handle is coupled to the movable clamping jaw and coupled to the fixed handle by a linkage. An operating screw is secured to the fixed handle and cooperates with one end of the linkage to facilitate adjustment of the movable clamping jaw relative to the fixed clamping jaw. The operating screw has a box end socket recess, in the remote end thereof, which facilitates remote actuation of the operating screw and facilities remote driving of the operating screw in a desired rotational direction so that a desired clamping force may be applied by the fixed and the movable clamping jaws to a desired object to be clamped. A method of using the hose clamp locking plier is also disclosed.

### FIELD OF THE INVENTION

The present invention relates to an improved hose clamp locking plier and a method of using the same to facilitate installation and/or removal of a desired object, such as a wide band self-adjusting spring hose or tube clamp (commonly referred to as an automotive coolant hose clamp).

### BACKGROUND OF THE INVENTION

Wide band spring hose clamps are commonly utilized, by numerous automobile manufacturers, as original equipment hose clamps for the coolant system. When such clamps are in an open area and readily accessible, these clamps are easy to install and remove with currently available tools. However, once an automobile is fully assembled, typically many obstacles hinder installation and/or removal of such spring hose clamps with currently available tools. The hoses themselves often interfere with access to the spring hose clamps. In addition, engine accessories and components such as the alternator, the power steering pump, the air conditioning pump, engine compartment wiring and hydraulic lines, various engine compartment brackets, the intake air filter assembly, the accessory drive belts, various engine compartment control cables, etc., all decrease the available space within the engine compartment and lead to reduced access to the spring hose clamps. Once all the necessary equipment is installed under the hood of an automobile, there generally remains insufficient room to easily install and/or remove such spring hose clamps by use of currently available locking pliers.

All currently available locking plier designs (for example, a conventional pair of VICE GRIP® pliers) require that the pair of handles 3, 5 be spread apart from one another and moved toward one another in order to operate the jaws 7, 9, i.e., to facilitate opening and closing of the jaws. In addition, most plier designs do not have directly forward facing jaws which means that, in addition to the space required for opening the handles, even more space is required for the tool to approach the desired clamp from various angles, e.g., a somewhat sideway angle of less than 90 degrees. As a result of this, in order to gain sufficient space for spreading the plier handles apart from one another, a mechanic must often remove one or more other installed engine component(s) from the engine compartment, such as the alternator, the drive belt, the breather assembly, etc. Once the mechanic has expended the additional time and labor removing such component(s) in order to gain sufficient space around the clamp, the mechanic may still find that the tips of the pliers do not adequately engage the remote ends of the spring hose clamp to allow easy removal thereof. This is especially true when the removal tool is gripping the spring hose clamp at the angle, as opposed to head on, whereby the tips can often become disengaged or slip off from their engagement with the remote ends of the spring hose clamp.

The common “long reach” style locking plier (see FIG. 2, for example) as well as a variety of other locking plier hose clamp tools normally have an adjustment screw 11 threadedly engaging the remote end of the stationary handle. The trailing exposed end of the adjustment screw 11 commonly has a textured surface (see FIGS. 1-3)—usually a deep knurl or ribbed surface—which is suitable to facilitate secure grasping between the thumb and forefinger of an operator. As the operator rotates the adjustment screw 11, such rotation adjusts or alters the clamping range of the tool or locking plier 1. For example, rotation of the adjustment screw 11 in a counter clockwise direction generally spaces the jaws 7, 9 further apart from one another to facilitate clamping of the tool or locking plier 1 to a “larger” object while rotation of the adjustment screw 11 in a clockwise direction, for example, biases the jaws 7, 9 closer together to facilitate clamping of the tool or locking plier to a “smaller” object. Once the adjustment screw 11 is suitably adjusted, the operator still must “open” and/or “close” the tool or locking plier 1 by biasing the movable handle 5 either toward or away from the stationary handle 3. The operator normally adjusts the adjustment screw 11 before hand so that, upon clamping the locking plier to the workpiece or object by biasing the movable handle toward the stationary handle, the operator will feel some resistance, just prior to the tool or locking plier 1 being fully closed, so that as the operator forces the movable and stationary handles 3, 5 into their fully closed position the tool 1 “locks” onto and clamps the workpiece or object. The locking plier 1 is released from the locked position by actuation of a conventional release lever 15, which is located behind, and extends beyond, the outward facing surface of the movable handle 5. The long reach locking pliers and the Snap-On® brand hose clamp locking plier, generally all have relatively slender jaws (see FIG. 3), with relatively slender tips.

The commonly available long reach locking pliers, supplied by various manufacturers, typically have jaws that project forward at a slight angle, at an angle of approximately 8 degrees or so for example, relative the stationary handle. The Snap-On® brand hose clamp plier#VGP13910 has front facing jaws, but does not include the other advances and improvements of the present invention.

### SUMMARY OF THE INVENTION

Wherefore, it is an object of the present invention to overcome the above mentioned shortcomings and drawbacks associated with the prior art locking pliers.

An object of the present invention is to provide a more effective and efficient locking plier for use when servicing coolant hose clamps so as to save both time and labor thereby rendering servicing of coolant hoses, for example, more profitable for the mechanic and/or the shop owner while, at the same time, faster and less costly for automobile owners.

Another object of the present invention is to reconfigure conventional hose clamp locking pliers so as to make the locking pliers particularly suitable for servicing, i.e., installing and removing, wide band self-tightening hose tube clamps.

A further object of the present invention is to facilitate operation of the improved hose clamp locking plier by way of a “drivable” operating screw, so as to allow the operator to remotely apply a desired clamping force, as well as to remotely decrease the desired clamping force, while the stationary handle and the movable handle can remain, at all times during the servicing operation, in a parallel and compact aligned configuration.

Yet another object of the present invention is to allow an operator to remotely apply sufficient torque to the plier jaw tips to service the hose clamp, by rotation of the operating screw, while ensuring that the improved hose clamp locking plier does note become inadvertently dislodged or disconnected from the object being clamped, and to be able to perform this operation while the tool is tightly wedged between installed engine components, where spreading the movable and the stationary handles apart from one another, as is normally required in order to operate other locking plier tools, is not possible.

A still further object of the present invention is to provide a pair of circular or disk-shaped clamping surfaces, at the remote, free end of the long slender clamping jaws of the improved hose clamp locking plier, to increase the size of and improve the clamping surface of the improved hose clamp locking plier and thereby facilitate use of the improved hose clamp locking plier in a variety of different orientations while still achieving a secure grip between the disk-shaped clamping surfaces and the object(s) being clamped.

Still another object of the present invention is to align the fixed clamping jaw so that this jaw substantially coincides with an axis defined by the fixed handle and extending parallel to the longitudinal axis of the improved hose clamp locking plier to improve manipulation and/or positioning of the improved hose clamp locking plier in area(s) which have limited maneuvering room.

A further object of the present invention to minimize the amount of components and other engine accessories which must be removed from an engine compartment in order for a mechanic to gain sufficient access to a spring hose clamp to facilitate removal thereof during servicing of a vehicle.

Yet another object of the present invention is to minimize the countless hours of frustrating labor required to service an engine and thereby increase the profitability of the shop owner and reduce the associated cost to an automobile owner required in servicing an automobile.

Still another object of the present invention is to provide a streamlined procedure or method for using the improved hose clamp locking plier, to facilitate removal and/or installation of a self-tightening spring hose clamp, while minimizing the time and effort associated with such procedure or method.

The present invention also relates to an improved hose clamp locking plier comprising: a fixed handle supporting a fixed clamping jaw; a movable clamping jaw being pivotally supported by the fixed handle and movable relative to the fixed clamping jaw; a movable handle being coupled to the movable clamping jaw and the movable handle being coupled to the fixed handle by a linkage; and an operating screw being secured to the fixed handle and cooperating with an end of the linkage to facilitate adjustment of the movable clamping jaw relative to the fixed clamping jaw; wherein the operating screw has a box end socket recess, in the remote end thereof, which facilitates remote actuation of the operating screw and facilities remote driving of the operating screw in a desired rotational direction so that a desired clamping force may be applied by the fixed and the movable clamping jaws and, in turn, to a desired object to be clamped.

The present invention also relates to a method of removing the spring hose clamp from a hose using a hose clamp locking plier comprising: a fixed handle supporting a fixed clamping jaw; a movable clamping jaw being pivotally supported by the fixed handle and movable relative to the fixed clamping jaw; a movable handle being coupled to the movable clamping jaw and the movable handle being coupled to the fixed handle by a linkage; and an operating screw being secured to the fixed handle and cooperating with an end of the linkage to facilitate adjustment of the movable clamping jaw relative to the fixed clamping jaw; and the operating screw having a box end socket recess, in the remote end thereof, which facilitates remote actuation and driving of the operating screw, the method comprising the steps of: sandwiching remote ends of the spring hose clamp between the fixed and the movable clamping jaws; remotely actuating and driving the operating screw, via a drive member, to apply a desired clamping force to the fixed and the movable clamping jaws and sufficiently increase a diameter of the spring hose clamp; and removing the hose clamp from its installed position once a sufficient clamping force is applied to the hose clamp.

### BRIEF DESCRIPTION OF THE DRAWINGS

The invention will now be described, by way of example, with reference to the accompanying drawings in which:

FIG. 1 is a diagrammatic view of a conventional pair of prior art locking pliers;

FIG. 2 is a diagrammatic view showing the conventional pair of prior art long reach locking pliers in an open position prior to an operator adjusting the clamping range of the clamping jaws via rotation of the adjustment screw;

FIG. 3 is a diagrammatic view, similar to FIG. 2, of another pair of prior art locking pliers in a closed open position following rotation of the adjustment screw by an operator;

FIG. 3A is an enlarged view of the prior art adjustment screw, for the hose clamping plier of FIG. 3, with an associated lock nut;

FIG. 4 is a diagrammatic exploded view of the improved hose clamp locking plier, according to the present invention, showing the drive tool for driving the operating screw;

FIG. 5 is a left side elevational view of only the improved hose clamp locking plier of FIG. 4;

FIG. 5A is a diagrammatic perspective view of the operating screw for use with the improved hose clamp locking plier of FIGS. 4 and 5;

FIG. 5B is an alternative embodiment of the operating screw for use with the improved hose clamp locking plier of FIGS. 4 and 5;

FIG. 5C is a further embodiment of the operating screw for use with the improved hose clamp locking plier of FIGS. 4 and 5;

FIG. 5CC is an enlarged partial view showing a profile of the acme screw thread;

FIG. 5D is still another embodiment of the operating screw for use with the improved hose clamp locking plier of FIGS. 4 and 5

FIG. 5E is an end view of the improved operating screw in the direction of section line 5E-5E;

FIG. 5F is a cross sectional view of the head portion of the improved operating screw of FIG. 5D taken along section line 5F-5F;

FIG. 6 is diagrammatic exploded view showing actuation or “driving” of the operating screw by another driving tool, in either a counter clockwise direction or clockwise direction, to facilitate change in the spacing of the two clamping jaws relative to one another;

FIG. 6A is a diagrammatic perspective view showing a wide band self-tightening hose clamp of FIG. 6;

FIG. 7 is a diagrammatic view showing the 180 degree range of entry for the improved hose clamp locking plier, according to the present invention, to facilitate engagement of the disk-shaped clamping surfaces with a desired object from a variety of different entry orientations;

FIG. 8 is another diagrammatic view of the improved hose clamp locking plier according to the present invention; and

FIG. 9 is a diagrammatic view of a second embodiment of the improved hose clamp locking plier according to the present invention.

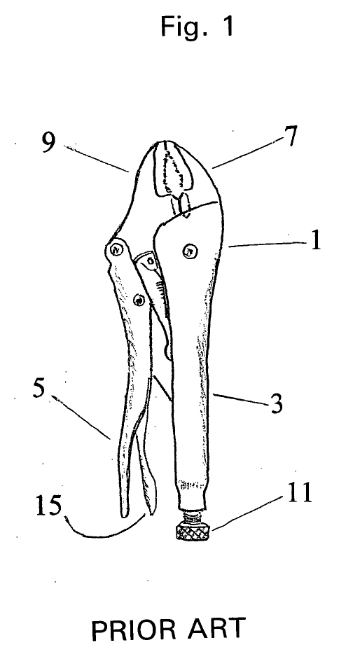

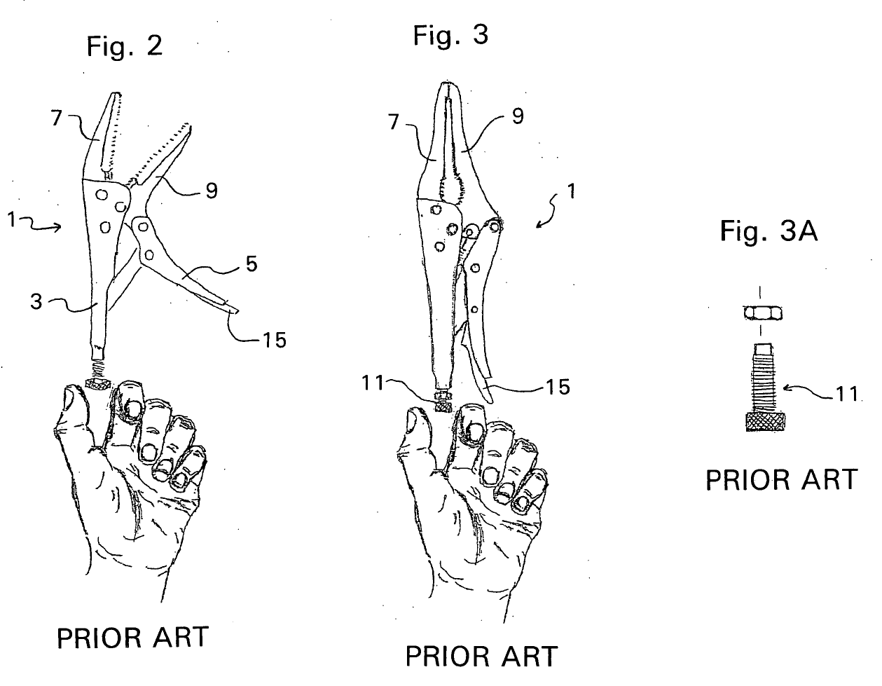

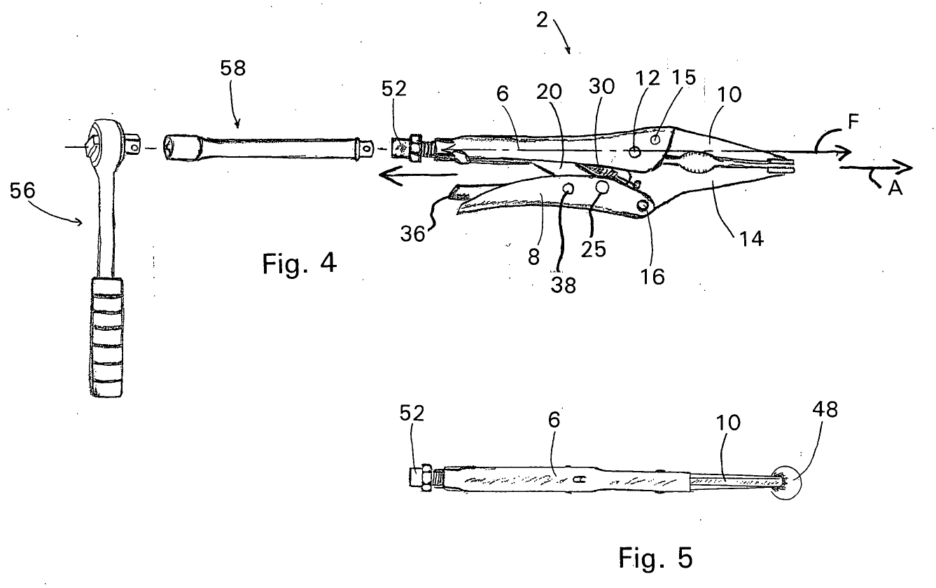

### DETAILED DESCRIPTION OF THE INVENTION

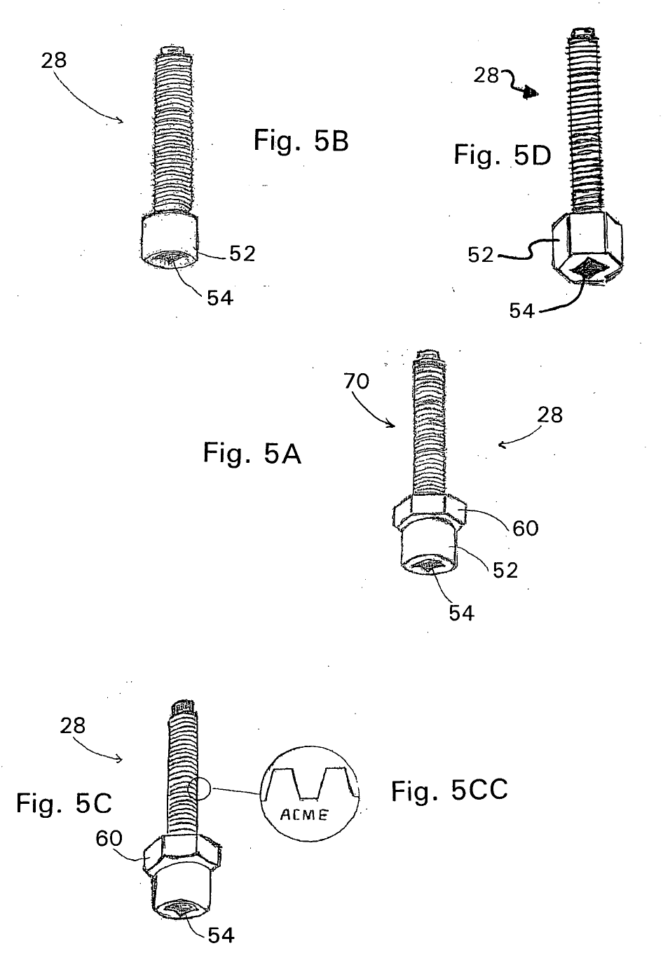

With reference to FIGS. 4, 5 and 8, a brief description concerning the various components of the improved hose clamp locking plier 2 will now first be provided. This discussion will then be followed by a detailed description concerning the method of using the improved hose clamp locking plier 2 to facilitate removal and/or installation of a self-tightening spring hose clamp 4, for example.

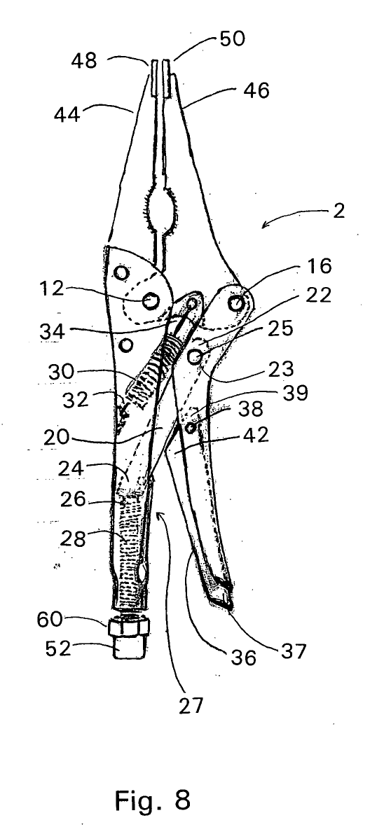

As can be seen in those Figures, the improved hose clamp locking plier 2 generally comprises both a stationary or fixed handle 6 and an adjustable or movable handle 8. The fixed handle 6 is directly connected to a fixed clamping jaw 10 in a conventional fashion, e.g., by rivets 15, welding, or formed integrally therewith for example. The movable clamping jaw 14 is pivotally connected to the fixed handle 6 by a first pivot 12, such as a rivet, and the movable handle 8, in turn, is pivotally connected to a movable clamping jaw 14 by a second pivot 16, such as a rivet. A linkage 20 couples the movable handle 8 with the fixed handle 6. That is, a first end 22 of the linkage 20 has an opening 23 therein (see FIG. 8) which facilitates pivotal connected of the first end of the linkage 20 to the movable handle 8 by a third pivot 25, such as a rivet, located adjacent the second pivot 16 of the movable handle 8 but spaced further away from the movable jaw 14. An opposed second end 24 of the linkage 20 is received within an internal recess 27 of the fixed handle 6 and abuttingly engages with a leading end 26 of the operating screw 28. The operating screw 28 is rotatable or drivable by an operator, in either a clockwise or a counter clockwise direction, in order to alter the relative position of the second end 24 of the linkage 20 relative to the fixed handle 6. Such adjustment of the linkage 20 correspondingly changes the position of the movable handle 8 and, in turn, the movable jaw 14 relative to the fixed handle 6, i.e., gradually increases or decreases the parallel spacing of the movable handle 8 relative to the fixed handle 6 which, in turn, translates into altering a wide range of motion of the movable clamping jaw 14 relative to the fixed clamping jaw 10 but rotation of the operating screw 28 does not cause the handles to “open.”

A first end 32 of a tension spring 30 is received within the internal recess 27 and is connected, in a conventional fashion, to the fixed handle 6 while a second end 34 of the tension spring 30 is connected, in a conventional fashion via an aperture for example, to the movable clamping jaw 14. The spring tension of the tension spring 30 normally biases the movable clamping jaw 14 into an “open” position spaced apart from the fixed clamping jaw 10. As the operating screw 28 is rotated in a clockwise direction, the linkage 20 forces the movable handle 8 and the movable jaw 14 to rotate about first pivot 12 and move towards the fixed clamping jaw 10 to thereby apply a clamp force to a desired object located between the fixed and movable clamping jaws 10, 14.

As is convention in the art, the movable handle 8 pivotally supports, via a fourth pivot 38, a release lever 36. A remote free end 37 of the release lever 36 extends past the movable handle 8 and is located so as to be actuatable by an operator while an opposed pivoted second end 39 of the release lever 36 is located closely adjacent and engagable with the linkage 20. The second pivoted end 39 of the release lever 36 includes a prying surface located to engage with the linkage 20.

When the improved hose clamp locking plier 2 is in its “locked” position, as shown in FIG. 8 for example, the linkage 20 is slightly “overcenter” relative to a line formed by the second and third pivots 16, 25, and the tension spring 30 maintains the linkage in this overcenter position which retains the fixed and movable clamping jaws 10, 14 in their “locked” position. However, when the release lever 36 is actuated and moved toward the fixed handle 6, the prying surface of the release lever 36 pries against an intermediate section of the linkage 20 so as to rotate slightly the remote free end of the movable handle 8 about the second pivot 16. Such rotation, in turn, pivots the first end 22 of the linkage 20, about the second end 24, away from the tension spring 30 and initially provides a slightly increasing clamping force, to the fixed and movable clamping jaws 10, 14, until the linkage 20 becomes precisely aligned with both the second and the third pivots 16, 25. As soon as the first end 22 of the linkage 20 passes “overcenter” such that the linkage 20 is no longer precisely aligned with both the second and the third pivots 16, 25 but is now is spaced further away from the tension spring 30, the tension spring 30 then operates to biases the movable clamping jaw 14 away from the fixed clamping jaw 10 and releases the “locking” action provided by the fixed and movable clamping jaws 10, 14. Due to the positioning of the second and third pivots 16, 25 and the linkage 30 to be aligned in an overcenter arrangement, the movable handle 8 will remain, due to its connection and on its own accord, in a parallel position relative to the fixed handle 6.

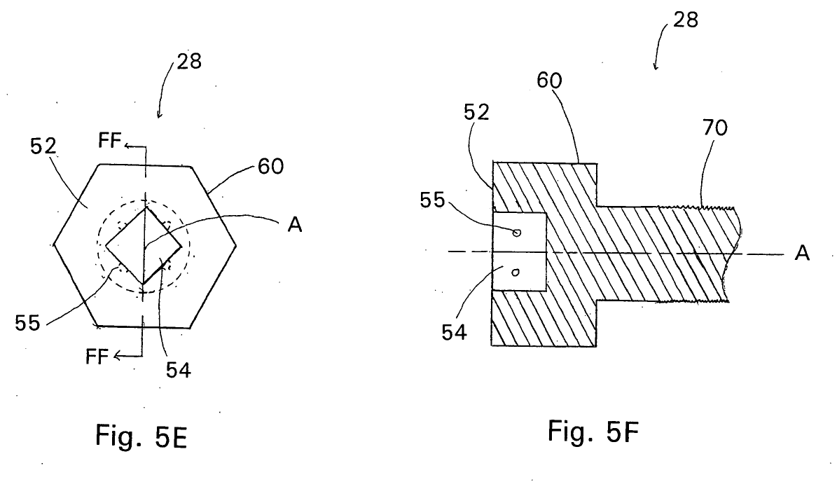

The improved hose clamp locking plier 2 of FIGS. 4 and 5 includes the following unique improvements over conventional common “long reach” locking pliers. First, the operating screw 28 may have a variety of different designs, see FIGS. 5A-5F for example, but the operating screw 28 must be remotely “drivable,” that is, the screw must facilitate remote actuation thereof by engagement with a driving tool for remotely “opening” and “closing” the fixed and movable clamping jaws 10, 14 relative to one another, e.g., especially where there is insufficient space to move the movable handle 8 relative to the fixed handle 6 in a conventional fashion. For example, the operating screw 28, when rotated in a clockwise direction, increases the clamping force to be exerted or applied by the fixed and the movable clamping jaws 10, 14 and the operating screw 28, when rotated in a counter clockwise direction, decreases clamping force to be exerted or applied by the fixed and the movable clamping jaws 10, 14. A further detail discussion concerning the remote increasing or decreasing of the clamping force applied to the fixed and the movable clamping jaws 10, 14 will follow below.

A second improvement according to the improved hose clamp locking plier 2 of the present invention is that the remote leading ends 44, 46 of both the fixed and the movable clamping jaws 10, 14 carries or terminates in a disk-shaped clamping surface 48, 50. The disk-shaped clamping surfaces 48, 50 improve the ability of the improved hose clamp locking plier 2 to reliably and securely engage the wide band adjusting spring type hose clamp, for example, and also permit clamping of the desired object or item from a variety of different orientations so as to improve the versatility of the hose clamp locking plier 2. The disk-shaped clamping surfaces 48, 50 typically have a diameter of between about 1.0 inches to about 0.25 inches, for example, more preferably the disk-shaped clamping surfaces 48, 50 each have a diameter of about 0.625 inches or so. It is to be appreciated that the overall size and shape of the disk-shape clamping surfaces 48, 50 can vary, as required or necessary, depending upon the particular application, e.g., the disk-shaped clamping surfaces 48, 50 may be round, oval, hexagonal, square, etc., and may possibly have an indentation or recess in the surface to further assist with retaining engagement with a desired object to be clamped. In addition, the opposed faces of the disk-shaped clamping surfaces 48, 50 may have teeth or a textured or a knurled surface, for example, so as to maximize the grip provided by the fixed and the movable clamping jaws 10, 14 to the object being clamped and thereby minimize the possibility of the clamping jaws 10, 14 becoming inadvertently disengaged or dislodged therefrom.

The third improvement in the improved hose clamp locking plier 2, according to the present invention, is that the conventional offset angle, e.g., of about 8 degrees or so, between the fixed handle and the fixed clamping jaw of known prior art locking pliers is preferably eliminated so that the fixed clamping jaw 10 and the fixed handle 6, of the improved hose clamp locking plier 2, are both substantially axially aligned with one another along a fixed jaw/fixed handle axis F which is spaced slightly from but extends substantially parallel to the central longitudinal axis A of the improved hose clamp locking plier 2 (see FIG. 4). Such modification further facilitates utilization of the hose clamp locking plier 2, in especially small, tight and/or confined operating spaces.

With reference to FIG. 5A, various aspects of the operating screw 28, according to the present invention, will now be discussed. As can be seen in this Figure, the operating screw 28 has a conventional screw thread 70, e.g., the screw thread has a length of between about one (1) inch and about three (3) inches or so and is typically a screw thread between M8 and M12, for example. In addition, a trailing end face of the exposed head 52 of the operating screw 28 is provided with a box end socket recess 54, e.g., having an opening of typically about ¼×¼ inches square or about ⅜×⅜ inches square, for example, and has a depth of about ⅜ to ½ inches or so. The box end socket recess 54 facilitates receipt of a conventional square drive end of a square drive tool or a ratchet 56, for example, or a conventional drive tool extension member 58 which may be attached to the drive component of a ratchet 56, as shown in FIG. 4. The drive tool extension member 58 facilitates increasing the distance or spacing between the drive end of the ratchet 56 and the object being clamped while still allowing remote actuation or driving of the operating screw 28. In addition, the head 52 of the operating screw 28 may be provided with at least two and preferably six equally spaced conventional wrench flats 60, surrounding and located about a perimeter of the head accommodating the box end socket recess 54, to permit application of the desired clamping force to the pair of clamping jaws 10, 14, i.e., facilitate driving of the operating screw 28, by utilization of a conventional wrench, for example.

With reference to FIG. 5B, a basic version of the operating screw 28 is shown. According to this embodiment, the operating screw 28 includes the box end socket recess 54 which is sized to receive the square end of the square drive tool or the ratchet, as discussed above, but is not provided with any wrench flats which facilitate actuation of the operating screw 28 via a conventional wrench, for example.

With reference to FIG. 5C, a heavy duty version of the operating screw 28 of FIG. 5A is shown. This embodiment is very similar of the embodiments of FIGS. 5A and 5D except that the operating screw 28 is provided with a conventional “acme” type screw thread (see FIG. 5CC) which screw thread normally provides the operating screw 28 with a longer service life.

FIGS. 5D, 5E and 5F show another embodiment of the operating screw 28 according to the invention. As shown in the embodiment, the head is hexagonal and the side wall of the head is provided with wrench flats 60 for facilitate actuation of the operating screw 28 via a conventional wrench. In addition, as can be seen FIG. 5F, the box end socket recess 54 includes one or more retaining recesses 55, in an interior side wall thereof, which is located to engage with a conventional retractable spring biased ball supported by the drive end of the drive member, such as a ratch 56, or by the drive tool extension member 58. This retaining recess 55 is sized to receive the conventional retractable ball, supported by the drive end of the drive member or the drive tool extension member 58, and facilitate releasable retention of the engagement between the drive tool and the box end socket recess 54. As drive end of the ratchet 56 or the drive tool extension member 58 is received by the box end socket recess 54, the spring biased locking ball is initially compressed into the drive end of the ratchet 56 or the drive tool extension member 58 and, once completed received within the box end socket recess 54, the ball is spring biased into one of the retaining recesses 55 for retaining the engagement between the ratchet 56 or the drive tool extension member 58 and the box end socket recess 54.

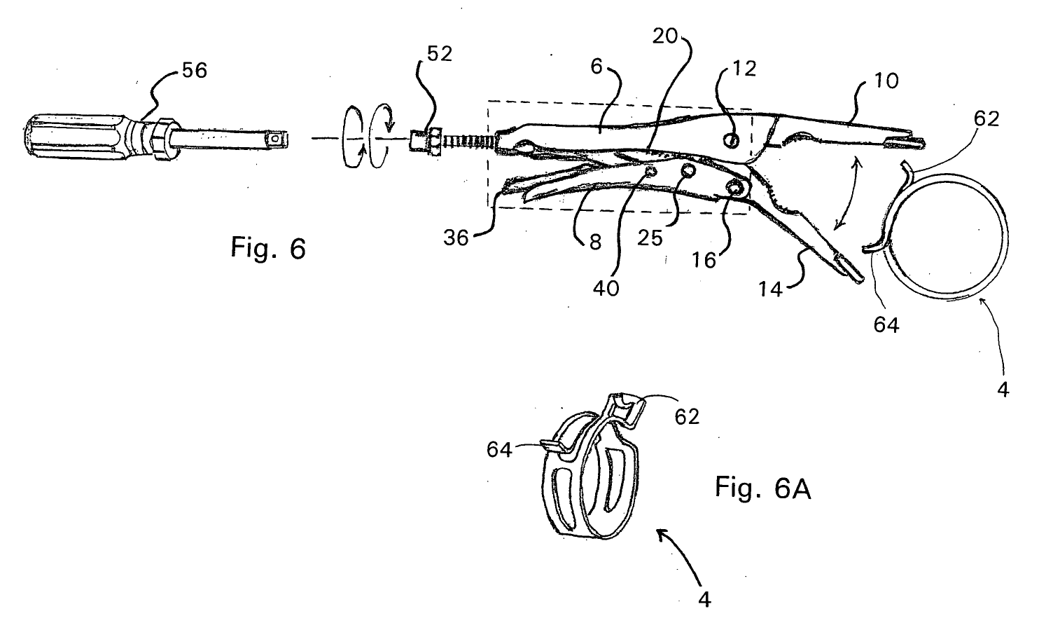

With reference now to FIG. 6, use of the improved hose clamp locking plier 2, for removing a spring hose clamp 4 as shown in FIG. 6A, will now be described. The operator first opens the fixed and the movable clamping jaws 10, 14 so that the fixed and the movable clamping jaws 10, 14 have a desired relative open orientation or position with respect to one another, i.e., by suitable rotation of the operating screw 28 in a desired rotational direction such as a counter clockwise direction. Once the operator determines that the fixed and the movable clamping jaws 10, 14 have their desired relative spacing or position with respect to one another such that they will easily be able to receive the two spaced apart free ends 60, 62 of the spring hose clamp 4 therebetween, the improved hose clamp locking plier 2 is then moved toward an engagement position relative to the two spaced apart free ends 62, 64 of the spring hose clamp 4, shown in FIG. 6A, so that the two disk-shape clamping surfaces 48, 50 are located in close proximity and sandwich the two free ends 62, 64 of the spring hose clamp 4 therebetween. Once this occurs, the operator maintains the improved hose clamp locking plier 2 substantially in this position or orientation while actuating or driving the operating screw 28 in a clockwise direction, for example, via a conventional ratchet 56, drive socket or some other tool which has a square drive end for engaging with the box end socket recess 54 provided in the head 52 of the operating screw 28, to bias or drive the fixed and the movable clamping jaws 10, 14 toward one another and securely engage and clamp the two spaced apart free ends 62, 64 of the spring hose clamp 4.

As a result of further clockwise rotation of the operating screw 28, the operator can then bias the two spaced apart free ends 62, 64 further toward one another and thereby sufficiently increase the diameter of the spring hose clamp 4 to adequately “open” the spring hose clamp 4 and facilitate easy removal thereof. Once the internal diameter of the spring hose clamp 4 is adequately increased in size by sufficient compression of the two spaced apart free ends 62, 64 toward one another, the operator can then slide the spring hose clamp 4 relative to the hose or tube from its installed position in a conventional fashion.

Due to the disk-shape clamping surfaces 48, 50 and the clamping force applied by the improved hose clamp locking plier 2, the hose clamp locking pliers 2 securely engage with the two remote ends 62, 64 of the spring hose clamp 4 without any concern that the spring hose clamp locking plier 2 will become inadvertently dislodged or disconnected from the spring hose clamp 4.

It is to be appreciated that if an operator desired to utilize the improved hose clamp locking plier 2 to apply a spring hose clamp 4, the present invention is suitable for this purpose as well and the above procedure is merely repeated in the reverse order. That is, the disk-shape clamping surfaces 48, 50 of the improved hose clamp locking plier 2 first engage with the two remote ends 62, 64 of the spring hose clamp 4 and the improved hose clamp locking plier 2 is actuated or driven, as discussed above, to sufficiently increase the diameter of the spring hose clamp 4 so that the spring hose clamp 4 may readily slide relative to the exterior surface of the desired hose or tube to be clamped by the spring hose clamp 4. Next, the spring hose clamp 4 is then positioned in its desired location by manipulation of the improved hose clamp locking plier 2. Once the spring hose clamp 4 is suitably positioned with respect to a desired hose or tube, the ratchet 56 or the drive tool extension member 58 engaged with the box end socket recess 54 of the operating screw 28, is utilized to rotate or drive the operating screw 28 in a desired direction, e.g., a counter clockwise direction, so as to gradually decrease the clamping force applied by the fixed and the movable clamping jaws 10, 14 to the two remote ends 62, 64 of the spring hose clamp 4. This, in turn, gradually increases the clamping force being applied by the spring hose clamp 4 to the hose or tube until the spring hose clamp locking plier 2 finally releases the two remote ends 62, 64 of the spring hose clamp 4 with the spring hose clamp 4 being installed at the installed position and exerting a desired clamping on the hose or tube.

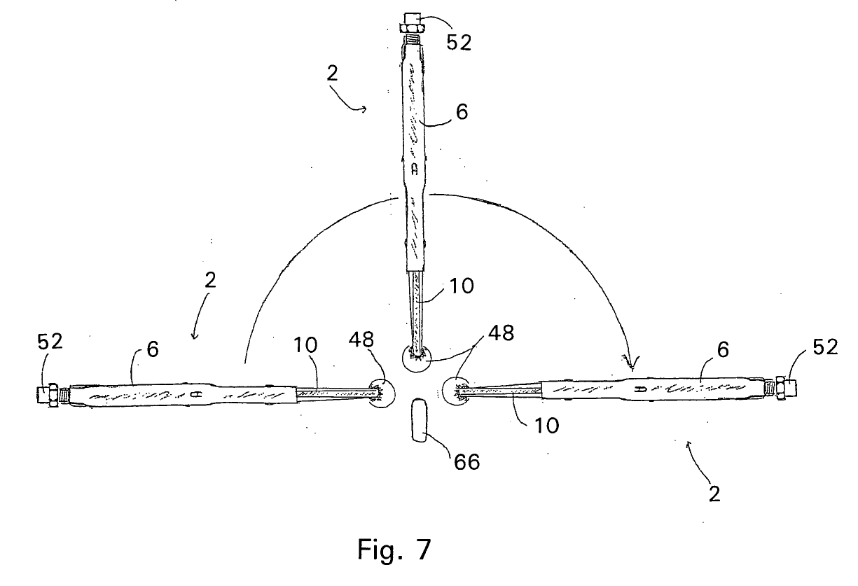

With reference to FIG. 7, an improved range of application, provided by the disk-shape clamping surfaces 48, 50 of the improved hose clamp locking plier 2, will now be discussed. As can be seen in this Figure, the improved hose clamp locking plier 2 can adequately and securely clamp a desired component or object to be clamped 66 over a hundred and eighty degree, or more, range of application. The disk-like clamping surfaces 48, 50 facilitate secure and firm gripping and grasping of the desired component or object 66, e.g., the remote ends of clamp, and over a wide range of angles and approach or entry positions. That is, the component or object to be clamped 66 may be clamped either head on, from either side of the disk-like clamping surfaces 48, 50 or from any angle in between.

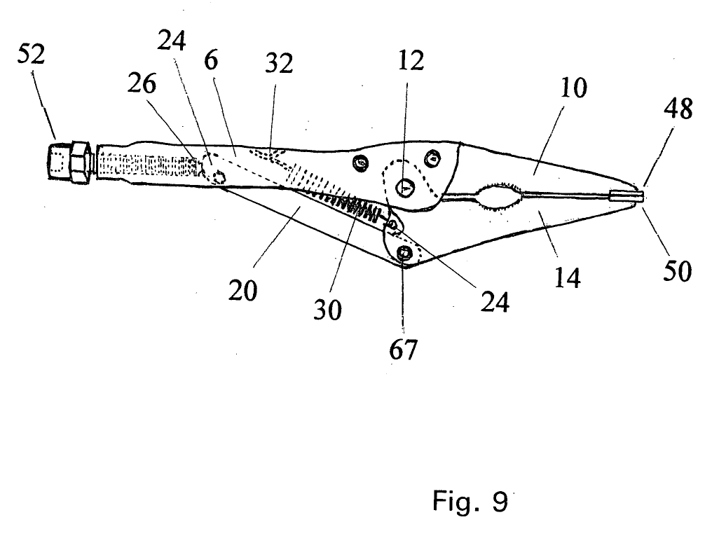

With reference to FIG. 9, another embodiment of the hose clamp locking plier 2 will now be described. The hose clamp locking plier 2, according to this embodiment, has a movable clamping jaw 14, similar to the movable clamping jaw 14 of the first embodiment, and is pivotally connected to the fixed handle 6 by the fixed pivot 12. Also, a tension spring 30 has a first end 32 connected to the fixed handle 6 and a second end 34 connected to the movable clamping jaw 14 to facilitate biasing the movable clamping jaw 14 into its open position spaced apart from the fixed clamping jaw 10. The linkage 20, however, directly couples the movable clamping jaw 14 to the fixed handle 6—the movable handle is eliminated in this embodiment. A first end 22 of the linkage 20 is pivotally directly connected to the movable clamping jaw 14, via fixed pivot 67, while the second end 24 of the linkage 20 is received by the internal recess 27 and engages with a leading end 26 of the operating screw 28. The operating screw 28 is rotatable by an operator, in either a clockwise or a counter clockwise direction, in order to facilitate driving and adjustment of the position of the second end 24 of the linkage 20 relative to the fixed handle 6. Such adjustment, in turn, adjusts the relative position of the movable clamping jaw 14 relative to the fixed clamping jaw 10. This embodiment has the advantage over the first embodiment, by eliminating the movable handle and the release lever, and thus simplifies manufacturing and reduces the associated manufacturing costs of the improved hose clamp locking plier 2.

The improved hose clamp locking plier 2, according to the present invention, facilitates application of a desired clamping force in confined working spaces where there may be insufficient room to adequately spread the fixed and the movable handles 6, 8 apart from one another, in a conventional manner, in order to facilitate actuation of the fixed and movable clamping jaws 10, 14. By providing an operating screw 28, which has a box end socket recess 54 in the exposed head 52 of the operating screw 28, this allows the mechanic or other operator to choose from a wide variety of commonly available conventional drive tools and accessories to facilitated actuation or driving of the improved hose clamp locking plier 2. In addition, if the operating screw 28 includes conventional wrench flats 60, the mechanic or operator can use either a flat wrench or an open or box style wrench to facilitate desired rotation or driving of the operating screw 28.

Since certain changes may be made in the above described hose clamp locking plier, without departing from the spirit and scope of the present invention, it is intended that all of the subject matter of the above description or shown in the accompanying drawings shall be interpreted merely as examples illustrating the inventive concept herein and shall not be construed as limiting the invention.

1. An improved hose clamp locking plier comprising:
a fixed handle supporting a fixed clamping jaw;
a movable clamping jaw being pivotally supported by the fixed handle and movable relative to the fixed clamping jaw;
a movable handle being coupled to the movable clamping jaw and the movable handle being coupled to the fixed handle by a linkage; and
an operating screw being secured to the fixed handle and cooperating with a second end of the linkage to facilitate adjustment of the movable clamping jaw relative to the fixed clamping jaw;
wherein a trailing end face of a head of the operating screw has a box end socket recess therein which is sized to facilitate receiving a square drive tool and facilitate remote actuation of the operating screw and remote driving of the operating screw in a first rotational direction so that a desired clamping force may be applied by the fixed and the movable clamping jaws and, in turn, to a desired object to be clamped, and remote driving of the operating screw in a second opposite rotational direction so that the desired clamping force to the desired object may be decreased.

2. The improved hose clamp locking plier according to claim 1, wherein the remote end of the fixed clamping jaw has a disk-shaped clamping surface fixed thereto and a remote end of the movable clamping jaw has a disk-shaped clamping surface fixed thereto and the pair of disk-shape clamping surfaces facilitate clamping of a desired object to be clamped therebetween

3. The improved hose clamp locking plier according to claim 1, wherein the fixed handle and the fixed clamping jaw are substantially axially aligned with one another along a common axis which extends substantially parallel to a longitudinal axis of the improved hose clamp locking plier but is spaced therefrom.

4. The improved hose clamp locking plier according to claim 1, wherein the fixed handle and the fixed clamping jaw are secured to one another to form a unitary component.

5. The improved hose clamp locking plier according to claim 1, wherein the fixed handle and the fixed clamping jaw are formed together as a unitary component.

6. The improved hose clamp locking plier according to claim 1, wherein a tension spring couples the fixed handle to the movable clamping jaw and biases the movable clamping jaw away from the fixed clamping jaw.

7. The improved hose clamp looking plier according to claim 1, wherein a first end of the linkage has an opening therein which facilitates pivotal connection of the first end of the linkage to the movable handle, while an opposed second end of the linkage is received by an internal recess of the fixed handle and abuttingly engages with a leading end of the operating screw.

8. (canceled)

9. The improved hose clamp locking plier according to claim 1, wherein the head of the operating screw is provided with wrench flats, located about an outer perimeter of the head, for engagement with one of a wrench and a socket.

10. The improved hose clamp locking plier according to claim 1, wherein the box end socket recess has en opening of between about ¼×¼ inches square and about ⅜×⅜ inches square, and a depth of about ⅜ to about ½ inch, and at least one side face of the box end socket recess has a retaining recesses located for engagement with a retractable spring biased member supported by a drive end of the drive tool for facilitating releasable locking engagement between the box end socket recess and the drive tool.

11. The improved hose clamp locking plier according to claim 1, wherein the operating screw has a screw thread with a length of between about one inch and about three inches.

12. The improved hose clamp locking plier according to claim 1, wherein the operating screw has a conventional acme type screw thread for increasing a service life of the operating screw.

13. An improved hose clamp locking plier comprising:
a fixed handle supporting a fixed clamping jaw;
a movable clamping jaw being pivotally supported by the fixed handle and movable relative to the fixed clamping jaw;
a movable handle being coupled to the movable clamping jaw and the movable handle being coupled to the fixed handle by a linkage; and
an operating screw being secured to the fixed handle and cooperating with an end of the linkage to facilitate adjustment of the movable clamping jaw relative to the fixed clamping jaw;
wherein the remote end of the fixed clamping jaw has a disk-shaped clamping surface fixed thereto and a remote end of the movable clamping jaw has a disk-shaped clamping surface fixed thereto and the pair of disk-shape clamping surfaces facilitate clamping of a desired object to be clamped therebetween; and
a trailing exposed end face of the head of the operating screw has a box end socket recess which facilitates receiving a square drive tool and remote actuation and driving of the operating screw, in a first rotational direction, so that a desired clamping force may be applied by the fixed and the movable clamping jaws and, in turn, to the desired object to be clamped, and remote actuation and driving of the operating screw in a second opposite rotational direction so that the desired clamping force, applied by the fixed and the movable clamping jaws to the desired object may be decreased.

14. The improved hose clamp locking plier according to claim 13, wherein a tension spring couples the fixed handle to the movable clamping jaw and biases the movable clamping jaw away from the fixed clamping jaw.

15. The improved hose clamp locking plier according to claim 14, wherein the fixed handle and the fixed clamping jaw are substantially axially aligned with one another along a common axis which extends substantially parallel to a longitudinal axis of the improved hose clamp locking plier but is spaced therefrom.

16. The improved hose clamp locking plier according to claim 1, wherein the head of the operating screw is provided with wrench flats, located about an outer perimeter of the head, for engagement with one of a wrench and a socket;
the box end socket recess has an opening of between about ¼×¼ inches square and about ⅜×⅜ inches square, and a depth of about ⅜ to about ½ inch;
the operating screw has a screw thread with a length of between about one inch and about three inches; and
at least one side face of the box end socket recess has a retaining recesses located for engagement with a retractable spring biased member supported by a drive end of the drive tool for facilitating releasable locking engagement between the box end socket recess and the drive tool.

17. A method of removing the spring hose clamp from a hose using a hose clamp locking plier comprising: a fixed handle supporting a fixed clamping jaw; a movable clamping jaw being pivotally supported by the fixed handle and movable relative to the fixed clamping jaw; a movable handle being coupled to the movable clamping jaw and the movable handle being coupled to the fixed handle by a linkage; and an operating screw being secured to the fixed handle and cooperating with an end of the linkage to facilitate adjustment of the movable clamping jaw relative to the fixed clamping jaw; and a trailing end face of a head of the operating screw having a box end socket recess therein which is sized to facilitate receiving a square drive tool which facilitates remote actuation and driving of the operating screw in both rotational directions,
the method comprising the steps of:
sandwiching remote ends of the spring hose clamp between the fixed and the movable clamping jaws;
remotely actuating and driving the operating screw, via a drive tool in a first rotational direction to apply a desired clamping force to the fixed and the movable clamping jaws and sufficiently increase a diameter of the spring hose clamp;
once the diameter of the spring hose clamp is sufficiently increased, removing the hose clamp from its installed position;
installing a new spring hose clamp; and
remotely actuating and driving the operating screw, via the drive tool in a second opposite rotational direction to decrease the desired clamping force to the fixed and the movable clamping jaws and sufficiently decrease a diameter of the spring hose clamp and facilitate installation thereof.

18. The method of removing the spring hose clamp according to claim 17, further comprising the step of remotely rotating the operating screw in a first direction by the drive tool engaging with the box end socket recess.

19. The method of removing the spring hose clamp according to claim 17, further comprising the steps of providing an outside perimeter of the head of the operating screw with wrench flats for remotely rotating and driving the operating screw in a first direction by the drive tool engaging with the wrench flats of the head; and
providing at least one side face of the box end socket recess with a retaining recesses located for engagement with a retractable spring biased member supported by a drive end of the drive member to facilitate releasable locking engagement between the box end socket recess and the drive member.

20. An improved hose clamp locking plier comprising:
a fixed handle supporting a fixed clamping jaw;
a movable clamping jaw being pivotally supported by the fixed handle and movable relative to the fixed clamping jaw;
the movable clamping jaw being coupled to the fixed handle by a linkage; and
an operating screw being secured to the fixed handle and cooperating with a second end of the linkage to facilitate adjustment of the movable clamping jaw relative to the fixed clamping jaw;
wherein a trailing end face of a head of the operating screw has a box end socket recess therein which is sized to facilitate receiving of a square drive tool and facilitate remote actuation of the operating screw and remote driving of the operating screw in a first rotational direction so that a desired clamping force may be applied by the fixed and the movable clamping jaws and, in turn, to a desired object to be clamped and remote actuation and driving of the operating screw in a second opposite rotational direction so that the clamping force applied by the fixed and the movable clamping jaws to the desired object may be decreased.
